(19) United States
(12) Patent Application Publication
(10) Pub. No.: US 2026/0295569 A1
(43) Pub. Date: Oct. 1, 2026

(54) CATALYTIC MATERIALS COMPRISING FE-CONTAINING ZEOLITIC MATERIAL FOR THE TREATMENT OF AN EXHAUST GAS

(71) Applicant: BASF CORPORATION, Florham Park, NJ (US)

(72) Inventors: Vivek VATTIPALLI, Iselin, NJ (US); Wen-Mei XUE, Iselin, NJ (US); Weiyong TANG, Iselin, NJ (US)

(21) Appl. No.: 19/489,108

(22) PCT Filed: Jun. 5, 2024
(86) PCT No.: PCT/EP2024/065477

§ 371 Date: Dec. 1, 2025

(30) Foreign Application Priority Data
Jun. 6, 2023 (EP) 23177621.2

(51) Int. Cl. B01J 29/68; B01D 53/94; B01J 23/745; B01J 37/04; B01J 37/30; F01N 3/08; F01N 3/20; F01N 3/28

(52) U.S. Cl. CPC B01J 29/68; B01D 53/9418; B01J 23/745; B01J 37/04; B01J 37/30; F01N 3/0842; F01N 3/2066; F01N 3/2803; B01D 2255/20738; B01D 2255/50; B01D 2257/404; B01D 2258/01; B01J 2229/183; F01N 2370/04

(57) ABSTRACT

An iron-containing catalytic material for the selective catalytic reduction of NOx in exhaust gas from an internal combustion engine. The catalytic material comprises a zeolitic material comprising SiO₂ and X₂O₃ in its framework structure, wherein X is a trivalent element such as aluminium, wherein the zeolitic material has an FER-type framework structure, wherein the deconvoluted ²⁹Si MAS NMR of the zeolitic material comprises a specific first peak (P1) corresponding to Q4(IAI) sites and having a maximum in the range of from −103.5 to −108.5 ppm with a certain minimum integral relative to three other peaks in the range of −90.0 to −130.0 ppm. The catalytic material also comprises Fe supported on the zeolitic material.

### TECHNICAL FIELD

The present invention relates to a catalytic material for the treatment of an exhaust gas compressing NOx, preferably for the selective catalytic reduction of NOx. Further, the present invention relates to a process for preparing a catalytic material, a catalytic material obtained or obtainable by said process, an exhaust gas treatment system using the catalytic material of the present invention, a process for the treatment of an exhaust gas using the catalytic material of the present invention, and use of a catalytic material according to the present invention for the treatment of an exhaust gas, preferably for the selective catalytic reduction of NOx.

### INTRODUCTION

The present invention pertains to the field of catalysts effective for selective catalytic reduction. Described are attributes of zeolitic materials having a framework structure having a maximum ring size of 10 T-atoms or less that provide best SCR performance when loaded with Fe. Further, a process for preparing a catalytic material is described herein allowing incorporation of comparatively high amounts of Fe into a zeolitic material.

WO 2020/021054 A1 relates to a process for preparing a zeolitic material having framework type FER. It is disclosed therein that the prepared zeolitic material can be ion-exchanged with ions of one or more of Cu, Pd, Rh, Pt and Fe.

WO 2021/198339 A1 relates to catalysts for the selective catalytic reduction of nitrogen oxide, processes for preparing said catalysts for the selective catalytic reduction of nitrogen oxide, use of a catalyst for the selective catalytic reduction of nitrogen oxide and an exhaust gas treatment system comprising said catalyst. The catalyst can comprise a zeolitic material having a framework structure type selected from the group consisting of MFI, MWW, AEL, HEU, FER, AFO, a mixture of two or more thereof and a mixed type of two or more thereof, wherein the zeolitic material can be ion-exchanged with Fe.

WO 2015/128668 A1 relates to SCR-active molecular sieve based-catalysts produced by combining a molecular sieve with at least one ionic iron species and at least one organic compound to form a mixture, then calcining the mixture to remove the at least one organic compound. It is disclosed that this process improves the dispersion of the iron within the molecular sieve compared to an iron-containing molecular sieve that is not treated with an organic compound. The prepared Fe-containing ferrierite zeolites were tested in the selective catalytic reduction of nitrogen oxides with NH₃ or urea.

EP 2857084 A1 relates to a device for treatment of exhaust gas flowing in an exhaust line of an internal combustion engine, characterized in that it comprises a porous substrate coated and/or impregnated with catalytic composition(s) combining a chabazite zeolite in the H-form or impregnated copper and/or a ferrierite zeolite in the H-form or impregnated with one or more of Cu and Fe.

DE 10 2011 012799 A1 relates to a catalyst comprising a carrier body of a certain length and a catalytically active coating made of at least one material zone which may comprise a zeolite containing 1-10 wt. % of copper, iron and/or silver, based on the total weight of the zeolite, where the zeolite may comprise ferrierite (FER).

EP 2409760 A1 relates to a gas-treatment device including such a composition comprising a ferrierite/iron-type zeolite. It is disclosed that the substrate has an internal structure that is adapted for forming a particulate filter (1) and has a catalytic composition comprising ferrierite zeolite in the H-form and containing iron (0.3-2 mass %) deposited on the substrate. The catalytic composition is configured for performing chemical reaction such as reduction of nitrogen oxide.

WO 2008/049557 A1 relates to a catalyst useful for decomposing and/or reduction of nitrous oxide, wherein the catalyst can comprise a ferrierite-type zeolite being Fe-exchanged.

U.S. Pat. No. 5,041,272 A relates to a method for removing nitrogen oxides from exhaust gases containing oxygen and moisture, which comprises bringing the exhaust gas into contact with hydrogenated zeolite catalysts or hydrogenated zeolite catalysts impregnated with one or more kinds of metals selected from the group consisting of copper, zinc, vanadium, chromium, manganese, iron, cobalt, nickel, rhodium, palladium, platinum, and molybdenum, in the presence of organic compounds. The zeolite may be of ferrierite type.

US 2011/056187 A1 relates to a process for treating diesel engine exhaust gases comprising nitrogen oxides (NOx) and hydrocarbons (HC) by selective catalytic reduction of the nitrogen oxides with ammonia or a compound decomposable to ammonia as a reducing agent over an SCR catalyst based on a molecular sieve.

P. Sarv et al., “Multinuclear MQMAS NMR Study of NH₄/Na-Ferrierites”, J. Phys. Chem. B 1998, 102, 1372-1378, relates to (MQ)MAS NMR as a method to study quadrupolar nuclei, enabling separation of the chemical shift interaction from the quadrupolar interaction. Illustrated are ²⁹Si MAS NMR spectra of a NH₄-ferrierites with a peak distribution in the range of from −90.0 to −120.0 ppm.

Accordingly, it was an object of the present invention to provide a catalytic material showing an improved performance in selective catalytic reduction (SCR), in particular in selective catalytic reduction of NOx. Especially, it was an object to provide a catalytic material showing an improved performance in selective catalytic reduction of NOx after aging. Further, it was an object of the present invention to provide a catalytic material showing an improved resistance to hydrocarbon poisoning. Additionally, it was an object of the present invention to provide a process for the preparation of a catalytic material, in particular allowing an improved ion-exchange, in particular with Fe, of a zeolitic material comprised in the catalytic material. Yet further, it was an object of the present invention to provide an exhaust gas treatment system comprising the catalytic material in accordance with the present invention. Exemplary designs for exhaust gas treatment systems in accordance with the present invention are shown in FIG. 14.

### DETAILED DESCRIPTION

Thus, it has surprisingly been found that a catalytic material can be provided showing a very good SCR performance, in particular after aging of the catalytic material. The inventive catalytic material, which is characterized by comprising a FER-type zeolitic material, especially shows an improved performance in selective catalytic reduction of NOx after aging and an improved resistance to hydrocarbon poisoning. Further, it was surprisingly found that use of one or more ammonium cations in the preparation of a catalytic material, in particular in combination with an adjustment of the pH of the respective aqueous reaction mixture, allows an improved incorporation of Fe into a zeolitic material comprised in a catalytic material.

Therefore, the present invention relates to a catalytic material for the selective catalytic reduction of NOx, the catalytic material comprising a zeolitic material comprising SiO₂ and X₂O₃ in its framework structure, wherein X is a trivalent element, wherein the zeolitic material has an FER-type framework structure, wherein the deconvoluted ²⁹Si MAS NMR of the zeolitic material comprises a first peak (P1) having a maximum in the range of from −103.5 to −108.5 ppm, wherein the integral of the first peak affords an area I₁, wherein the integral of all peaks in the range of −90.0 to −130.0 ppm afford an area Iₜₒₜₐₗ, wherein the ratio of the area I₁ of the first peak to the area Iₜₒₜₐₗ of all peaks is equal to or greater than 0.20:1, wherein the catalytic material comprises Fe, wherein Fe is supported on the zeolitic material, and wherein the deconvoluted ²⁹Si MAS NMR of the zeolitic material is preferably determined according to Reference Example 1.

There is no particular restriction according to the present invention as to the state in which the zeolitic material is subjected to the ²⁹Si MAS NMR experiment. It is however preferred that the values given in the present application relative to the ²⁹Si MAS NMR spectrum are obtained from the zeolitic material which has not been subject to any post-synthetic treatment and is therefore an untreated zeolitic material as-crystallized. According to the present invention it is, however, further preferred that the values given in the present application relative to the ²⁹Si MAS NMR spectrum are directly obtained from the zeolitic material as-crystallized wherein after isolation, washing and drying thereof, the material has only been subject to calcination, wherein preferably calcination has been conducted according to any of the particular and preferred embodiments as defined in the present application, wherein more preferably calcination has been conducted at 550° C. for a duration of 5 h under air.

It is preferred that the ratio of the area I₁ of the first peak to the area Iₜₒₜₐₗ of all peaks in the range of −90.0 to −130.0 ppm is equal to or greater than 0.23:1, more preferably greater than 0.25:1.

It is preferred that the ratio of the area I₁ of the first peak to the area Iₜₒₜₐₗ of all peaks in the range of −90.0 to −130.0 ppm is in the range of 0.2:1 to 0.60:1, more preferably in the range of 0.23:1 to 0.50:1, more preferably in the range of 0.30:1 to 0.50:1.

It is preferred that the first peak (P1) has a maximum in the range of −104.0 to −108.0 ppm, more preferably in the range of −104.5 to −107.5 ppm, more preferably in the range of −105.0 to −107.0 ppm.

It is preferred that the deconvoluted ²⁹Si MAS NMR of the zeolitic material comprises a second peak (P2) having a maximum in the range of −97.5 to −102.5 ppm, more preferably in the range of −99.0 to −101.0 ppm, wherein the integral of the second peak (P2) more preferably affords an area I₂, wherein the ratio of the area I₂ of the second peak to the area Iₜₒₜₐₗ of all peaks in the range of −90.0 to −130.0 ppm is equal to or smaller than 0.05:1, more preferably equal to or smaller than 0.04:1, more preferably equal to or smaller than 0.03:1.

It is preferred that the deconvoluted ²⁹Si MAS NMR of the zeolitic material comprises a third peak (P3) having a maximum in the range of −108.6 to −112.5 ppm, more preferably in the range of −110.0 to −112.0 ppm, wherein the integral of the third peak (P3) more preferably affords an area I₃, wherein the ratio of the area I₃ of the third peak to the area Iₜₒₜₐₗ of all peaks in the range of −90.0 to −130.0 ppm is equal to or smaller than 0.55:1, more preferably equal to or smaller than 0.50:1, more preferably equal to or smaller than 0.45:1.

It is preferred that the deconvoluted ²⁹Si MAS NMR of the zeolitic material comprises a fourth peak (P4) having a maximum in the range of −112.6 to −116.5 ppm, more preferably in the range of −113.0 to −115.0 ppm, wherein the integral of the fourth peak (P4) more preferably affords an area I₄, wherein the ratio of the area I₄ of the fourth peak to the area Iₜₒₜₐₗ of all peaks in the range of −90.0 to −130.0 ppm is equal to or smaller than 0.50:1, more preferably equal to or smaller than 0.45:1, more preferably equal to or smaller than 0.40:1.

It is preferred that the deconvoluted ²⁹Si MAS NMR of the zeolitic material comprises a fifth peak (P5) having a maximum in the range of −93.0 to −97.0 ppm, more preferably in the range of −94.0 to −96.0 ppm, wherein the integral of the fifth peak (P5) more preferably affords an area I₅, wherein the ratio of the area Is of the fifth peak to the area Iₜₒₜₐₗ of all peaks in the range of −90.0 to −130.0 ppm is equal to or smaller than 0.05:1, more preferably equal to or smaller than 0.3:1, more preferably equal to or smaller than 0.02:1.

It is preferred that X is selected from the group consisting of Al, B, In, Ga, and mixtures of two or more thereof, more preferably selected from the group consisting of Al, B, and a mixture thereof, wherein X more preferably is Al.

It is preferred that the zeolitic material has a molar ratio of SiO₂ to X₂O₃ of equal to or less than 50, more preferably of equal to or less than 40, more preferably of equal to or less than 30, more preferably in the range of from 1 to 30, more preferably in the range of from 5 to 25, more preferably in the range of from 10 to 20.

In the case where X is Al, it is preferred that the zeolitic material has a molar ratio of SiO₂ to Al₂O₃ of equal to or less than 50, more preferably of equal to or less than 40, more preferably of equal to or less than 30, more preferably in the range of from 1 to 30, more preferably in the range of from 5 to 25, more preferably in the range of from 10 to 20.

Furthermore and independently thereof, it is preferred according to a first alternative for the catalytic material, that the catalytic material has an atomic ratio of Fe supported on the zeolitic material, calculated as element, to Al comprised in the framework structure of the zeolitic material, calculated as element, of equal to or greater than 0.20:1, preferably in the range of 0.20:1 to 0.50:1, more preferably in the range of 0.20:1 to 0.45:1, more preferably in the range of 0.20:1 to 0.40:1, more preferably in the range of 0.20:1 to 0.35:1.

Furthermore and independently thereof, it is preferred according to a second alternative for the catalytic material, that the catalytic material comprises Fe, calculated as Fe₂O₃, supported on the zeolitic material, calculated as sum of the weights of SiO₂ and X₂O₃ comprised by the framework structure of the zeolitic material, in an amount of equal to or greater than 2.5 weight-%, more preferably in the range of 2.5 to 10.0 weight-%, more preferably in the range of 2.5 to 7.5 weight-%, more preferably in the range of 4.0 to 6.5 weight-%, more preferably in the range of 5.0 to 6.2 weight-%, more preferably in the range of 5.9 to 6.0 weight-%.

Further, the present invention relates to a process for producing a catalytic material, preferably for producing the catalytic material according to any one of the particular and preferred embodiments disclosed herein, the process comprising
(i) providing an aqueous mixture comprising a zeolitic material, one or more sources of Fe, and one or more optionally substituted ammonium cations;
(ii) subjecting the mixture obtained in (i) to ion-exchange conditions;
   wherein the zeolitic material comprises SiO₂ and X₂O₃ in its framework structure,
   wherein X is a trivalent element,
   wherein the zeolitic material has a maximum ring size of 10 T-atoms or less,
   wherein the deconvoluted ²⁹Si MAS NMR of the zeolitic material comprises a first peak (P1) having a maximum in the range of from −103.5 to −108.5 ppm, wherein the integral of the first peak affords an area I₁, wherein all peaks in the range of −90.0 to −130.0 ppm have an area Iₜₒₜₐₗ, wherein the ratio of the area I₁ of the first peak to the area Iₜₒₜₐₗ of all peaks is equal to or greater than 0.20:1, and Fe supported on the zeolitic material, wherein the deconvoluted ²⁹Si MAS NMR of the zeolitic material is preferably determined according to Reference Example 1.

In particular, supporting of Fe on a zeolitic material can be done via commonly known processes, especially via ion-exchange procedure, wherein the term “ion-exchange” according to the present invention generally refers to non-framework ionic elements and/or molecules contained in the zeolitic material. In general, any conceivable ion-exchange procedure with all possible ionic elements and/or molecules can be conducted on the zeolitic material, with the exception of organic structure directing agents specifically used in the synthesis of zeolitic materials. Preferably, as ionic elements at least one cation and/or cationic element is employed which is preferably selected from the group consisting of H⁺, NH₄⁺, and Fe. Further, a supporting, in particular an ion-exchange, can be conducted via impregnation, preferably via incipient wetness technique. Incipient wetness impregnation techniques, also called capillary impregnation or dry impregnation are commonly used for the synthesis of heterogeneous materials, i.e., catalysts. As a result, the Fe can be supported on a zeolitic material as metal cluster and/or as metal oxide.

It is preferred that the ratio of the area I₁ of the first peak to the area Iₜₒₜₐₗ of all peaks in the range of −90.0 to −130.0 ppm is equal to or greater than 0.23:1, more preferably greater than 0.25:1.

It is preferred that the ratio of the area I₁ of the first peak to the area Iₜₒₜₐₗ of all peaks in the range of −90.0 to −130.0 ppm is in the range of 0.2:1 to 0.60:1, more preferably in the range of 0.23:1 to 0.50:1, more preferably in the range of 0.25:1 to 0.45:1.

It is preferred that the first peak (P1) has a maximum in the range of −104.0 to −108.0 ppm, more preferably in the range of −104.5 to −107.0 ppm, more preferably in the range of −105.0 to −107.0 ppm.

It is preferred that the deconvoluted ²⁹Si MAS NMR of the zeolitic material comprises a second peak (P2) having a maximum in the range of −97.5 to −102.5 ppm, more preferably in the range of −99.0 to −101.0 ppm, wherein the integral of the second peak (P2) preferably affords an area I₂, wherein the ratio of the area I₂ of the second peak to the area Iₜₒₜₐₗ of all peaks in the range of −90.0 to −130.0 ppm is equal to or smaller than 0.05:1, more preferably equal to or smaller than 0.04:1, more preferably equal to or smaller than 0.03:1.

It is preferred that the deconvoluted ²⁹Si MAS NMR of the zeolitic material comprises a third peak (P3) having a maximum in the range of −108.6 to −112.5 ppm, more preferably in the range of −110.0 to −112.0 ppm, wherein the integral of the third peak (P3) more preferably affords an area I₃, wherein the ratio of the area Is of the third peak to the area total of all peaks in the range of −90.0 to −130.0 ppm is equal to or smaller than 0.55:1, more preferably equal to or smaller than 0.50:1, more preferably equal to or smaller than 0.45:1.

It is preferred that the deconvoluted ²⁹Si MAS NMR of the zeolitic material comprises a fourth peak (P4) having a maximum in the range of −112.6 to −116.5 ppm, more preferably in the range of −113.0 to −115.0 ppm, wherein the integral of the fourth peak (P4) more preferably affords an area I₄, wherein the ratio of the area I₄ of the fourth peak to the area Iₜₒₜₐₗ of all peaks in the range of −90.0 to −130.0 ppm is equal to or smaller than 0.50:1, more preferably equal to or smaller than 0.45:1, more preferably equal to or smaller than 0.40:1.

It is preferred that the deconvoluted ²⁹Si MAS NMR of the zeolitic material comprises a fifth peak (P5) having a maximum in the range of −93.0 to −97.0 ppm, more preferably in the range of −94.0 to −96.0 ppm, wherein the integral of the fifth peak (P5) more preferably affords an area I₅, wherein the ratio of the area I₅ of the fifth peak to the area Iₜₒₜₐₗ of all peaks in the range of −90.0 to −130.0 ppm is equal to or smaller than 0.05:1, more preferably equal to or smaller than 0.3:1, more preferably equal to or smaller than 0.02:1.

It is preferred that X is selected from the group consisting of Al, B, In, Ga, and mixtures of two or more thereof, more preferably selected from the group consisting of Al, B, and a mixture thereof, wherein X more preferably is Al.

It is preferred that the zeolitic material has a molar ratio of SiO₂ to X₂O₃ of equal to or less than 50, more preferably of equal to or less than 40, more preferably of equal to or less than 30, more preferably in the range of from 1 to 30, more preferably in the range of from 5 to 25, more preferably in the range of from 10 to 20.

It is preferred that the one or more optionally substituted ammonium cations are selected from the group consisting of NH₄⁺, ((C₁-C₁₀)alkyl)NH₃⁺, ((C₁-C₁₀)alkyl)₂NH₂⁺, ((C₁-C₁₀)alkyl)₃NH⁺, ((C₁-C₁₀) alkyl)₄N⁺, and mixtures of two or more thereof, more preferably from the group consisting of NH₄⁺, ((C₁-C₇)alkyl)NH₃⁺, ((C₁-C₇)alkyl)₂NH₂⁺, ((C₁-C₇)alkyl)₃NH⁺, ((C₁-C₇)alkyl)₄N⁺, and mixtures of two or more thereof, more preferably from the group consisting of NH₄⁺, ((C₁-C₅)alkyl)NH₃⁺, ((C₁-C₅)alkyl)₂NH₂⁺, ((C₁-C₅)alkyl)₃NH⁺, ((C₁-C₅)alkyl)₄N⁺, and mixtures of two or more thereof, more preferably from the group consisting of NH₄⁺, ((C₁-C₃)alkyl)NH₃⁺, ((C₁-C₃)alkyl)₂NH₂⁺, ((C₁-C₃) alkyl)₃NH⁺, ((C₁-C₃)alkyl)₄N⁺, and mixtures of two or more thereof, more preferably from the group consisting of NH₄⁺, ((C₂-C₃)alkyl)NH₃⁺, ((C₂-C₃)alkyl)₂NH₂⁺, ((C₂-C₃)alkyl)₃NH⁺, ((C₂-C₃)alkyl) ₄N⁺, and mixtures of two or more thereof, more preferably from the group consisting of NH₄⁺, (C₂alkyl)NH₃⁺, (C₂alkyl)₂NH₂⁺, (C₂alkyl)₃NH⁺, (C₂alkyl)₄N⁺, and mixtures of two or more thereof, wherein the one or more optionally substituted ammonium cations are more preferably one or more of NH₄⁺ and tetraethylammonium.

It is preferred that the one or more sources of Fe are selected from the group consisting of Fe nitrates, Fe citrates, ammonium Fe citrates, Fe acetates, Fe sulfates, Fe ascorbates, and mixtures of two or more thereof, more preferably from the group consisting of Fe (III) nitrate, Fe (III) citrate, ammonium Fe (III) citrate, Fe (III) acetate, Fe (III) sulfate, Fe (III) ascorbate, and mixtures of two or more thereof, wherein the one or more sources of Fe more preferably are Fe (III) nitrate.

It is preferred that the mixture obtained in (i) has a weight ratio of water to the zeolitic material in the range of 4.0:1 to 10.0:1, more preferably in the range of 5.0:1 to 9.0:1, more preferably in the range of 6.0:1 to 8.0:1, more preferably in the range of 6.5:1 to 7.5:1.

It is preferred that the pH of the mixture obtained in (i) has a pH in the range of 3.0 to 7.0, more preferably in the range of 3.5 to 6.5, more preferably in the range of 4.0 to 6.0, more preferably in the range of 4.5 to 5.5.

It is preferred that the zeolitic material comprised in the mixture provided in (i) has an AEI-, AFT-, AFX-, CHA-, FER-, or MFI-type framework structure, more preferably a CHA-, FER-, or MFI-type framework structure, more preferably a CHA- or FER-type framework structure, more preferably a FER-type framework structure.

It is preferred that the ion-exchange conditions comprise heating the mixture obtained in (i) to a temperature in the range of 30 to 100° C., more preferably in the range of 35 to 80° C., more preferably in the range of 40 to 70° C., more preferably in the range of 45 to 65° C.

It is preferred that the ion-exchange conditions are applied in (ii) for a duration in the range of 0.1 to 48 h, more preferably in the range of 0.5 to 25 h, more preferably in the range of 1 to 5 h.

It is preferred that the ion-exchange conditions comprise stirring the mixture obtained in (i).

It is preferred that the process further comprises after (ii)
(s) separating the catalytic material obtained in (ii), preferably by filtration.

It is preferred that the process further comprises after (ii), more preferably after(s) as defined herein above,
(w) washing the catalytic material obtained in (ii), more preferably after(s), with water, wherein washing is more preferably performed until the water has a conductivity of less than 200 μS.

It is preferred that the process further comprises after (ii), more preferably after(s), more preferably after (w)
(d) drying the catalytic material obtained in (ii), (s), or (w) in a gas atmosphere having a temperature in the range of 70 to 135° C., more preferably in the range of 80 to 120° C., more preferably in the range of 90 to 110° C.

It is preferred that the process further comprises after (ii), more preferably after(s), more preferably after (w), more preferably after (d),
(c) calcining the catalytic material obtained in (ii), (s), (w), or (d) in a gas atmosphere having a temperature in the range of 400 to 600° C., more preferably in the range of 420 to 500° C., more preferably in the range of 440 to 460° C., wherein calcining is more preferably performed for a duration in the range of 0.5 to 24 h, more preferably in the range of 1 to 5 h.

In the case where the process further comprises (c), it is preferred that the gas atmosphere according to (c) comprises one or more of nitrogen and oxygen, wherein the gas atmosphere more preferably comprises, more preferably consists of, air.

It is preferred that the process further comprises after (ii), more preferably after(s), more preferably after (w), more preferably after (d), more preferably after (c),
(m) molding a mixture comprising the catalytic material obtained in (ii), (s), (w), (d), or (c), and an optionally hydrated binder, wherein the binder more preferably comprises one or more of Zr acetate, pseudoboehmite, alumina, silica-alumina, and a mixture of two or more thereof, wherein the mixture comprises the binder, calculated as oxide, in an amount in the range of 1 to 10 weight-%, more preferably in the range of 4 to 6 weight-%, based on the sum of the weights of SiO₂ and X₂O₃ comprised in the framework structure of the zeolitic material.

In the case where the process further comprises (m), it is preferred that the process further comprises after (m)
(md) drying the mixture obtained in (m) in a gas atmosphere having a temperature in the range of 500 to 650° C., more preferably in the range of 560 to 620° C., more preferably in the range of 580 to 600° C.

Further in the case where the process further comprises (m), it is preferred that the process further comprises after (m), more preferably after (md) (mc) calcining the mixture obtained in (m) of (md) in a gas atmosphere having a temperature in the range of 500 to 650° C., more preferably in the range of 560 to 620° C., more preferably in the range of 580 to 600° C., wherein calcining is more preferably performed for a duration in the range of 0.5 to 24 h, more preferably in the range of 1 to 5 h.

In the case where the process further comprises (md) or (mc), it is preferred that the gas atmosphere in one or more of (md) and (mc), more preferably in (md) and (mc) comprises one or more of nitrogen and oxygen, wherein the gas atmosphere more preferably comprises, more preferably consists of, air.

Further in the case where the process further comprises (m), it is preferred that the process further comprises after (m), more preferably after (md), more preferably after (mc) (mcr) crushing the mixture obtained in (m), (md), or (mc), wherein further preferred that the process further comprises (msi) sieving the mixture obtained in (m), (md), (mc), or (mcr) to particles, more preferably with a sieve having a mesh in the range of 250 to 500 μm.

Yet further, the present invention relates to a catalytic material obtained or obtainable by the process of any one of the particular and preferred embodiments disclosed herein.

Yet further, the present invention relates to an exhaust gas treatment system comprising a component comprising the catalytic material of any one of the particular and preferred embodiments disclosed herein, an internal combustion engine and an exhaust gas conduit in fluid communication with the internal combustion engine, wherein the component comprising the catalytic material is present in the exhaust gas conduit.

It is preferred that the component comprising the catalytic material comprises a substrate, wherein said catalytic material is disposed on said substrate.

It is preferred that the internal combustion engine is a lean burn engine or a lean gasoline direct injection (GDI) engine, more preferably a diesel engine, more preferably a heavy duty diesel engine.

It is preferred that the exhaust gas treatment system further comprises a diesel oxidation catalyst (DOC), wherein the diesel oxidation catalyst is more preferably located upstream of the component comprising the catalytic material.

It is preferred that the exhaust gas treatment system further comprises an optionally catalyzed soot filter, wherein the optionally catalyzed soot filter is located upstream or downstream of the component comprising the catalytic material.

It is preferred that the exhaust gas treatment system further comprises an ammonia oxidation catalyst (AMOX), wherein the ammonia oxidation catalyst (AMOX) is located upstream or downstream of the component comprising the catalytic material.

Furthermore and independently thereof, it is preferred according to a first alternative for the exhaust gas treatment system that the exhaust gas treatment system comprises in consecutive order in the direction of the exhaust gas a SCR component, an ammonia oxidation catalyst (AMOX), a diesel oxidation catalyst (DOC), the component comprising the catalytic material, optionally a Cu-containing SCR component, and an ammonia oxidation catalyst (AMOX).

Furthermore and independently thereof, it is preferred according to a second alternative for the exhaust gas treatment system that the exhaust gas treatment system comprises in consecutive order in the direction of the exhaust gas the component comprising the catalytic material, an ammonia oxidation catalyst (AMOX), a diesel oxidation catalyst (DOC), optionally a Cu-containing SCR component, and an ammonia oxidation catalyst (AMOX).

Furthermore and independently thereof, it is preferred according to a third alternative for the exhaust gas treatment system that the exhaust gas treatment system comprises in consecutive order in the direction of the exhaust gas a hydrocarbon injector, a diesel oxidation catalyst (DOC), a catalyzed soot filter (CSF), an urea injector, the component comprising the catalytic material, and a combined selective catalytic reduction/ammonia oxidation catalyst.

Furthermore and independently thereof, it is preferred according to a fourth alternative for the exhaust gas treatment system that the exhaust gas treatment system comprises in consecutive order in the direction of the exhaust gas an urea injector, a close coupled selective catalytic reduction (cc-SCR), a hydrocarbon injector, a diesel oxidation catalyst (DOC), a catalyzed soot filter (CSF), an urea injector, the component comprising the catalytic material, and a combined selective catalytic reduction/ammonia oxidation catalyst.

It is preferred that the exhaust gas treatment system further comprises a reductant injector, wherein the reductant injector is more preferably located upstream of the component comprising the catalytic material, more preferably between the diesel oxidation catalyst (DOC) and the component comprising the catalytic material as defined for the first alternative for the exhaust gas treatment system herein above, or between the internal combustion engine and the component comprising the catalytic material as defined for the second alternative for the exhaust gas treatment system herein above.

In the case where the exhaust gas treatment system further comprises a reductant injector, it is preferred that the reductant comprises, more preferably consists of, one or more of ammonia, a hydrocarbon, and urea.

Yet further, the present invention relates to a process for the treatment of an exhaust gas, preferably for the selective catalytic reduction of NOx comprised in an exhaust gas, the process comprising bringing the exhaust gas stream in contact with a catalytic material according to any one of the particular and preferred embodiments disclosed herein.

Yet further, the present invention relates to use of a catalytic material according to any one of the particular and preferred embodiments disclosed herein or of an exhaust gas treatment system according to any one of the particular and preferred embodiments disclosed herein for the treatment of an exhaust gas comprising NOx, preferably for the selective catalytic reduction (SCR) of NOx comprised in an exhaust gas.

The present invention is further illustrated by the following set of embodiments and combinations of embodiments resulting from the dependencies and back-references as indicated. In particular, it is noted that in each instance where a range of embodiments is mentioned, for example in the context of a term such as “The catalytic material of any one of embodiments 1 to 4”, every embodiment in this range is meant to be explicitly disclosed for the skilled person, i.e. the wording of this term is to be understood by the skilled person as being synonymous to “The catalytic material of any one of embodiments 1, 2, 3, and 4”. Further, it is explicitly noted that the following set of embodiments is not the set of claims determining the extent of protection, but represents a suitably structured part of the description directed to general and preferred aspects of the present invention.
1. A catalytic material for the selective catalytic reduction of NOx, the catalytic material comprising
   a zeolitic material comprising SiO₂ and X₂O₃ in its framework structure,
   wherein X is a trivalent element,
   wherein the zeolitic material has an FER-type framework structure,
   wherein the deconvoluted ²⁹Si MAS NMR of the zeolitic material comprises a first peak (P1) having a maximum in the range of from −103.5 to −108.5 ppm, wherein the integral of the first peak affords an area I₁, wherein the integral of all peaks in the range of −90.0 to −130.0 ppm afford an area Iₜₒₜₐₗ, wherein the ratio of the area I₁ of the first peak to the area Iₜₒₜₐₗ of all peaks is equal to or greater than 0.20:1,
   wherein the catalytic material comprises Fe, wherein Fe is supported on the zeolitic material, and
   wherein the deconvoluted ²⁹Si MAS NMR of the zeolitic material is preferably determined according to Reference Example 1.
2. The catalytic material of embodiment 1, wherein the ratio of the area I₁ of the first peak to the area Iₜₒₜₐₗ of all peaks in the range of −90.0 to −130.0 ppm is equal to or greater than 0.23:1, preferably greater than 0.25:1.
3. The catalytic material of embodiment 1 or 2, wherein the ratio of the area I₁ of the first peak to the area Iₜₒₜₐₗ of all peaks in the range of −90.0 to −130.0 ppm is in the range of 0.2:1 to 0.60:1, preferably in the range of 0.23:1 to 0.50:1, more preferably in the range of 0.30:1 to 0.50:1.
4. The catalytic material of any one of embodiments 1 to 3, wherein the first peak (P1) has a maximum in the range of −104.0 to −108.0 ppm, preferably in the range of −104.5 to −107.5 ppm, more preferably in the range of −105.0 to −107.0 ppm.
5. The catalytic material of any one of embodiments 1 to 4, wherein the deconvoluted ²⁹Si MAS NMR of the zeolitic material comprises a second peak (P2) having a maximum in the range of −97.5 to −102.5 ppm, preferably in the range of −99.0 to −101.0 ppm, wherein the integral of the second peak (P2) preferably affords an area I₂, wherein the ratio of the area I₂ of the second peak to the area Iₜₒₜₐₗ of all peaks in the range of −90.0 to −130.0 ppm is equal to or smaller than 0.05:1, preferably equal to or smaller than 0.04:1, more preferably equal to or smaller than 0.03:1.
6. The catalytic material of any one of embodiments 1 to 5, wherein the deconvoluted ²⁹Si MAS NMR of the zeolitic material comprises a third peak (P3) having a maximum in the range of −108.6 to −112.5 ppm, preferably in the range of −110.0 to −112.0 ppm, wherein the integral of the third peak (P3) preferably affords an area I₃, wherein the ratio of the area I₃ of the third peak to the area Iₜₒₜₐₗ of all peaks in the range of −90.0 to −130.0 ppm is equal to or smaller than 0.55:1, preferably equal to or smaller than 0.50:1, more preferably equal to or smaller than 0.45:1.
7. The catalytic material of any one of embodiments 1 to 6, wherein the deconvoluted ²⁹Si MAS NMR of the zeolitic material comprises a fourth peak (P4) having a maximum in the range of −112.6 to −116.5 ppm, preferably in the range of −113.0 to −115.0 ppm, wherein the integral of the fourth peak (P4) preferably affords an area I₄, wherein the ratio of the area I₄ of the fourth peak to the area Iₜₒₜₐₗ of all peaks in the range of −90.0 to −130.0 ppm is equal to or smaller than 0.50:1, preferably equal to or smaller than 0.45:1, more preferably equal to or smaller than 0.40:1.
8. The catalytic material of any one of embodiments 1 to 7, wherein the deconvoluted ²⁹Si MAS NMR of the zeolitic material comprises a fifth peak (P5) having a maximum in the range of −93.0 to −97.0 ppm, preferably in the range of −94.0 to −96.0 ppm, wherein the integral of the fifth peak (P5) preferably affords an area I₅, wherein the ratio of the area I₅ of the fifth peak to the area Iₜₒₜₐₗ of all peaks in the range of −90.0 to −130.0 ppm is equal to or smaller than 0.05:1, preferably equal to or smaller than 0.3:1, more preferably equal to or smaller than 0.02:1.
9. The catalytic material of any one of embodiments 1 to 8, wherein X is selected from the group consisting of Al, B, In, Ga, and mixtures of two or more thereof, preferably selected from the group consisting of Al, B, and a mixture thereof, wherein X more preferably is Al.
10. The catalytic material of any one of embodiments 1 to 9, wherein the zeolitic material has a molar ratio of SiO₂ to X₂O₃ of equal to or less than 50, preferably of equal to or less than 40, more preferably of equal to or less than 30, more preferably in the range of from 1 to 30, more preferably in the range of from 5 to 25, more preferably in the range of from 10 to 20.
11. The catalytic material of any one of embodiments 1 to 9, wherein X is Al and wherein the zeolitic material has a molar ratio of SiO₂ to Al₂O₃ of equal to or less than 50, preferably of equal to or less than 40, more preferably of equal to or less than 30, more preferably in the range of from 1 to 30, more preferably in the range of from 5 to 25, more preferably in the range of from 10 to 20.
12. The catalytic material of any one of embodiments 1 to 11, having an atomic ratio of Fe supported on the zeolitic material, calculated as element, to Al comprised in the framework structure of the zeolitic material, calculated as element, of equal to or greater than 0.20:1, preferably in the range of 0.20:1 to 0.50:1, more preferably in the range of 0.20:1 to 0.45:1, more preferably in the range of 0.20:1 to 0.40:1, more preferably in the range of 0.20:1 to 0.35:1.
13. The catalytic material of any one of embodiments 1 to 11, comprising Fe, calculated as Fe₂O₃, supported on the zeolitic material, calculated as sum of the weights of SiO₂ and X₂O₃ comprised by the framework structure of the zeolitic material, in an amount of equal to or greater than 2.5 weight-%, preferably in the range of 2.5 to 10.0 weight-%, more preferably in the range of 2.5 to 7.5 weight-%, more preferably in the range of 4.0 to 6.5 weight-%, more preferably in the range of 5.0 to 6.2 weight-%, more preferably in the range of 5.9 to 6.0 weight-%.
14. A process for producing a catalytic material, preferably for producing the catalytic material according to any one of embodiments 1 to 13, the process comprising
   (i) providing an aqueous mixture comprising a zeolitic material, one or more sources of Fe, and one or more optionally substituted ammonium cations;
   (ii) subjecting the mixture obtained in (i) to ion-exchange conditions;
   wherein the zeolitic material comprises SiO₂ and X₂O₃ in its framework structure,
   wherein X is a trivalent element,
   wherein the zeolitic material has a maximum ring size of 10 T-atoms or less,
   wherein the deconvoluted ²⁹Si MAS NMR of the zeolitic material comprises a first peak (P1) having a maximum in the range of from −103.5 to −108.5 ppm, wherein the integral of the first peak affords an area I₁, wherein all peaks in the range of −90.0 to −130.0 ppm have an area Iₜₒₜₐₗ, wherein the ratio of the area I₁ of the first peak to the area Iₜₒₜₐₗ of all peaks is equal to or greater than 0.20:1, and Fe supported on the zeolitic material, wherein the deconvoluted ²⁹Si MAS NMR of the zeolitic material is preferably determined according to Reference Example 1.
15. The process of embodiment 14, wherein the ratio of the area I₁ of the first peak to the area Iₜₒₜₐₗ of all peaks in the range of −90.0 to −130.0 ppm is equal to or greater than 0.23:1, preferably greater than 0.25:1.
16. The process of embodiment 14 or 15, wherein the ratio of the area I₁ of the first peak to the area Iₜₒₜₐₗ of all peaks in the range of −90.0 to −130.0 ppm is in the range of 0.2:1 to 0.60:1, preferably in the range of 0.23:1 to 0.50:1, more preferably in the range of 0.25:1 to 0.45:1.
17. The process of any one of embodiments 14 to 16, wherein the first peak (P1) has a maximum in the range of −104.0 to −108.0 ppm, preferably in the range of −104.5 to −107.0 ppm, more preferably in the range of −105.0 to −107.0 ppm.
18. The process of any one of embodiments 14 to 17, wherein the deconvoluted ²⁹Si MAS NMR of the zeolitic material comprises a second peak (P2) having a maximum in the range of −97.5 to −102.5 ppm, preferably in the range of −99.0 to −101.0 ppm, wherein the integral of the second peak (P2) preferably affords an area I₂, wherein the ratio of the area I₂ of the second peak to the area Iₜₒₜₐₗ of all peaks in the range of −90.0 to −130.0 ppm is equal to or smaller than 0.05:1, preferably equal to or smaller than 0.04:1, more preferably equal to or smaller than 0.03:1.
19. The process of any one of embodiments 14 to 18, wherein the deconvoluted ²⁹Si MAS NMR of the zeolitic material comprises a third peak (P3) having a maximum in the range of −108.6 to −112.5 ppm, preferably in the range of −110.0 to −112.0 ppm, wherein the integral of the third peak (P3) preferably affords an area I₃, wherein the ratio of the area I₃ of the third peak to the area Iₜₒₜₐₗ of all peaks in the range of −90.0 to −130.0 ppm is equal to or smaller than 0.55:1, preferably equal to or smaller than 0.50:1, more preferably equal to or smaller than 0.45:1.
20. The process of any one of embodiments 14 to 19, wherein the deconvoluted ²⁹Si MAS NMR of the zeolitic material comprises a fourth peak (P4) having a maximum in the range of −112.6 to −116.5 ppm, preferably in the range of −113.0 to −115.0 ppm, wherein the integral of the fourth peak (P4) preferably affords an area I₄, wherein the ratio of the area I₄ of the fourth peak to the area Iₜₒₜₐₗ of all peaks in the range of −90.0 to −130.0 ppm is equal to or smaller than 0.50:1, preferably equal to or smaller than 0.45:1, more preferably equal to or smaller than 0.40:1.
21. The process of any one of embodiments 14 to 20, wherein the deconvoluted ²⁹Si MAS NMR of the zeolitic material comprises a fifth peak (P5) having a maximum in the range of −93.0 to −97.0 ppm, preferably in the range of −94.0 to −96.0 ppm, wherein the integral of the fifth peak (P5) preferably affords an area I₅, wherein the ratio of the area I₅ of the fifth peak to the area Iₜₒₜₐₗ of all peaks in the range of −90.0 to −130.0 ppm is equal to or smaller than 0.05:1, preferably equal to or smaller than 0.3:1, more preferably equal to or smaller than 0.02:1.
22. The process of any one of embodiments 14 to 21, wherein X is selected from the group consisting of Al, B, In, Ga, and mixtures of two or more thereof, preferably selected from the group consisting of Al, B, and a mixture thereof, wherein X more preferably is Al.
23. The process of any one of embodiments 14 to 22, wherein the zeolitic material has a molar ratio of SiO₂ to X₂O₃ of equal to or less than 50, preferably of equal to or less than 40, more preferably of equal to or less than 30, more preferably in the range of from 1 to 30, more preferably in the range of from 5 to 25, more preferably in the range of from 10 to 20.
24. The process of any one of embodiments 14 to 23, wherein the one or more optionally substituted ammonium cations are selected from the group consisting of NH₄⁺, ((C₁-C₁₀)alkyl) NH₃⁺, ((C₁-C₁₀)alkyl)₂NH₂⁺, ((C₁-C₁₀)alkyl)₃NH⁺, ((C₁-C₁₀)alkyl)₄N⁺, and mixtures of two or more thereof, preferably from the group consisting of NH₄⁺, ((C₁-C₇)alkyl)NH₃⁺, ((C₁-C₂) alkyl)₂NH₂⁺, ((C₁-C₇)alkyl)₃NH⁺, ((C₁-C₇)alkyl)₄N⁺, and mixtures of two or more thereof, more preferably from the group consisting of NH₄⁺, ((C₁-C₅)alkyl)NH₃⁺, ((C₁-C₅)alkyl)₂NH₂⁺, ((C₁-C₅)alkyl)₃NH⁺, ((C₁-C₅)alkyl)₄N⁺, and mixtures of two or more thereof, more preferably from the group consisting of NH₄⁺, ((C₁-C₃)alkyl)NH₃⁺, ((C₁-C₃)alkyl)₂NH₂⁺, ((C₁-C₃)alkyl) ₃NH⁺, ((C₁-C₃)alkyl)₄N⁺, and mixtures of two or more thereof, more preferably from the group consisting of NH₄⁺, ((C₂-C₃)alkyl)NH₃⁺, ((C₂-C₃)alkyl)₂NH₂⁺, ((C₂-C₃)alkyl)₃NH⁺, ((C₂-C₃) alkyl)₄N⁺, and mixtures of two or more thereof, more preferably from the group consisting of NH₄⁺, (C₂alkyl)NH₃⁺, (C₂alkyl)₂NH₂⁺, (C₂alkyl)₃NH⁺, (C₂alkyl)₄N⁺, and mixtures of two or more thereof, wherein the one or more optionally substituted ammonium cations are more preferably one or more of NH₄+ and tetraethylammonium.
25. The process of any one of embodiments 14 to 24, wherein the one or more sources of Fe are selected from the group consisting of Fe nitrates, Fe citrates, ammonium Fe citrates, Fe acetates, Fe sulfates, Fe ascorbates, and mixtures of two or more thereof, preferably from the group consisting of Fe (III) nitrate, Fe (III) citrate, ammonium Fe (III) citrate, Fe (III) acetate, Fe (III) sulfate, Fe (III) ascorbate, and mixtures of two or more thereof, wherein the one or more sources of Fe more preferably are Fe (III) nitrate.
26. The process of any one of embodiments 14 to 25, wherein the mixture obtained in (i) has a weight ratio of water to the zeolitic material in the range of 4.0:1 to 10.0:1, preferably in the range of 5.0:1 to 9.0:1, more preferably in the range of 6.0:1 to 8.0:1, more preferably in the range of 6.5:1 to 7.5:1.
27. The process of any one of embodiments 14 to 26, preferably of embodiment 26, wherein the pH of the mixture obtained in (i) has a pH in the range of 3.0 to 7.0, preferably in the range of 3.5 to 6.5, more preferably in the range of 4.0 to 6.0, more preferably in the range of 4.5 to 5.5.
28. The process of any one of embodiments 14 to 27, wherein the zeolitic material comprised in the mixture provided in (i) has an AEI-, AFT-, AFX-, CHA-, FER-, or MFI-type framework structure, preferably a CHA-, FER-, or MFI-type framework structure, more preferably a CHA- or FER-type framework structure, more preferably a FER-type framework structure.
29. The process of any one of embodiments 14 to 28, wherein the ion-exchange conditions comprise heating the mixture obtained in (i) to a temperature in the range of 30 to 100° C., preferably in the range of 35 to 80° C., more preferably in the range of 40 to 70° C., more preferably in the range of 45 to 65° C.
30. The process of any one of embodiments 14 to 29, wherein the ion-exchange conditions are applied in (ii) for a duration in the range of 0.1 to 48 h, preferably in the range of 0.5 to 25 h, more preferably in the range of 1 to 5 h.
31. The process of any one of embodiments 14 to 30, wherein the ion-exchange conditions comprise stirring the mixture obtained in (i).
32. The process of any one of embodiments 14 to 31, further comprising after (ii)
   (s) separating the catalytic material obtained in (ii), preferably by filtration.
33. The process of any one of embodiments 14 to 32, further comprising after (ii), preferably after(s) as defined in embodiment 32,
   (w) washing the catalytic material obtained in (ii), preferably after(s), with water, wherein washing is preferably performed until the water has a conductivity of less than 200 μS.
34. The process of any one of embodiments 14 to 33, further comprising after (ii), preferably after(s), more preferably after (w)
   (d) drying the catalytic material obtained in (ii), (s), or (w) in a gas atmosphere having a temperature in the range of 70 to 135° C., more preferably in the range of 80 to 120° C., preferably in the range of 90 to 110° C.
35. The process of any one of embodiments 14 to 34, further comprising after (ii), preferably after(s), more preferably after (w), more preferably after (d),
   (c) calcining the catalytic material obtained in (ii), (s), (w), or (d) in a gas atmosphere having a temperature in the range of 400 to 600° C., preferably in the range of 420 to 500° C., more preferably in the range of 440 to 460° C., wherein calcining is more preferably performed for a duration in the range of 0.5 to 24 h, preferably in the range of 1 to 5 h.
36. The process of embodiment 34 or 35, wherein the gas atmosphere comprises one or more of nitrogen and oxygen, wherein the gas atmosphere more preferably comprises, more preferably consists of, air.
37. The process of any one of embodiments 14 to 36, further comprising after (ii), preferably after(s), more preferably after (w), more preferably after (d), more preferably after (c), (m) molding a mixture comprising the catalytic material obtained in (ii), (s), (w), (d), or (c), and an optionally hydrated binder, wherein the binder preferably comprises one or more of Zr acetate, pseudoboehmite, alumina, silica-alumina, and a mixture of two or more thereof, wherein the mixture comprises the binder, calculated as oxide, in an amount in the range of 1 to 10 weight-%, preferably in the range of 4 to 6 weight-%, based on the sum of the weights of SiO₂ and X₂O₃ comprised in the framework structure of the zeolitic material.
38. The process of embodiment 37, further comprising after (m)
   (md) drying the mixture obtained in (m) in a gas atmosphere having a temperature in the range of 500 to 650° C., preferably in the range of 560 to 620° C., more preferably in the range of 580 to 600° C.
39. The process of embodiment 37 or 38, further comprising after (m), preferably after (md) (mc) calcining the mixture obtained in (m) in a gas atmosphere having a temperature in the range of 500 to 650° C., preferably in the range of 560 to 620° C., more preferably in the range of 580 to 600° C., wherein calcining is more preferably performed for a duration in the range of 0.5 to 24 h, preferably in the range of 1 to 5 h.
40. The process of embodiment 38 or 39, wherein the gas atmosphere comprises one or more of nitrogen and oxygen, wherein the gas atmosphere more preferably comprises, more preferably consists of, air.
41. The process of any one of embodiments 37 to 40, further comprising after (m), preferably after (md), more preferably after (mc)
   (mcr) crushing the mixture obtained in (m), (md), or (mc), and preferably further comprising
   (msi) sieving the mixture obtained in (m), (md), (mc), or (mcr) to particles, preferably with a sieve having a mesh in the range of 250 to 500 μm.
42. A catalytic material obtained or obtainable by the process of any one of embodiments 14 to 41.
43. An exhaust gas treatment system comprising a component comprising the catalytic material of any one of embodiments 1 to 13 and 42, an internal combustion engine and an exhaust gas conduit in fluid communication with the internal combustion engine, wherein the component comprising the catalytic material is present in the exhaust gas conduit.
44. The exhaust gas treatment system of embodiment 43, wherein the component comprising the catalytic material of any one of embodiments 1 to 13 and 42 comprises a substrate, wherein said catalytic material is disposed on said substrate.
45. The exhaust gas treatment system of embodiment 43 or 44, wherein the internal combustion engine is a lean burn engine or a lean gasoline direct injection (GDI) engine, more preferably a diesel engine, more preferably a heavy duty diesel engine.
46. The exhaust gas treatment system of any one of embodiments 43 to 45, further comprising a diesel oxidation catalyst (DOC), wherein the diesel oxidation catalyst is preferably located upstream of the component comprising the catalytic material of any one of embodiments 1 to 13 and 42.
47. The exhaust gas treatment system of any one of embodiments 43 to 46, further comprising an optionally catalyzed soot filter, wherein the optionally catalyzed soot filter is located upstream or downstream of the component comprising the catalytic material of any one of embodiments 1 to 13 and 42.
48. The exhaust gas treatment system of any one of embodiments 43 to 47, further comprising an ammonia oxidation catalyst (AMOX), wherein the ammonia oxidation catalyst (AMOX) is located upstream or downstream of the component comprising the catalytic material of any one of embodiments 1 to 13 and 42.
49. The exhaust gas treatment system of any one of embodiments 43 to 45, comprising in consecutive order in the direction of the exhaust gas a SCR component, an ammonia oxidation catalyst (AMOX), a diesel oxidation catalyst (DOC), the component comprising the catalytic material of any one of embodiments 1 to 13 and 42, optionally a Cu-containing SCR component, and an ammonia oxidation catalyst (AMOX).
50. The exhaust gas treatment system of any one of embodiments 43 to 45, comprising in consecutive order in the direction of the exhaust gas the component comprising the catalytic material of any one of embodiments 1 to 13 and 42, an ammonia oxidation catalyst (AMOX), a diesel oxidation catalyst (DOC), optionally a Cu-containing SCR component, and an ammonia oxidation catalyst (AMOX).
51. The exhaust gas treatment system of any one of embodiments 43 to 45, comprising in consecutive order in the direction of the exhaust gas a hydrocarbon injector, a diesel oxidation catalyst (DOC), a catalyzed soot filter (CSF), an urea injector, the component comprising the catalytic material of any one of embodiments 1 to 13 and 42, and a combined selective catalytic reduction/ammonia oxidation catalyst.
52. The exhaust gas treatment system of any one of embodiments 43 to 45, comprising in consecutive order in the direction of the exhaust gas an urea injector, a close coupled selective catalytic reduction (cc-SCR), a hydrocarbon injector, a diesel oxidation catalyst (DOC), a catalyzed soot filter (CSF), an urea injector, the component comprising the catalytic material of any one of embodiments 1 to 13 and 42, and a combined selective catalytic reduction/ammonia oxidation catalyst.
53. The exhaust gas treatment system of any one of embodiments 43 to 52, further comprising a reductant injector, wherein the reductant injector is preferably located upstream of the component comprising the catalytic material of any one of embodiments 1 to 13 and 42,
   preferably between the diesel oxidation catalyst (DOC) and the component comprising the catalytic material of any one of embodiments 1 to 13 and 42 as defined in embodiment 49, or between the internal combustion engine and the component comprising the catalytic material of any one of embodiments 1 to 13 and 42 as defined in embodiment 50.
54. The exhaust gas treatment system of embodiment 53, wherein the reductant comprises, more preferably consists of, one or more of ammonia, a hydrocarbon, and urea.
55. A process for the treatment of an exhaust gas, preferably for the selective catalytic reduction of NOx comprised in an exhaust gas, the process comprising bringing the exhaust gas stream in contact with a catalytic material according to any one of embodiments 1 to 13 and 42.
56. Use of a catalytic material according to any one of embodiments 1 to 13 and 42 or of an exhaust gas treatment system according to any one of embodiments 43 to 54 for the treatment of an exhaust gas comprising NOx, preferably for the selective catalytic reduction (SCR) of NOx comprised in an exhaust gas.

The present invention is further illustrated by the following reference examples, examples, and comparative examples.

### EXAMPLES

### Reference Example 1: ²⁹Si MAS NMR

²⁹Si MAS NMR measurements were run on a Varian Unity Inova 400 MHz spectrometer, using a 7.5 mm rotor spun at 3.5 kHz. Spectra were obtained using a 90 second recycle delay with 128 scans, and a 6.5 μs pi/2 pulse. Prior to measurement, samples were hydrated for at least 48 hours in a vessel containing a saturated solution of Ammonium Chloride to maintain a relative humidity of >80%. Spectra were fit and peaks deconvoluted with ACD Labs Spectrus software using mixed Gaussian/Lorentzian functions and peak position variability of <100 Hz. Expected peak assignments are Q₄(0Al) at −114 ppm and −111 ppm, Q₄ (1Al) at −106 ppm, and a potential overlap of Q₃(0Al) and Q₄ (2Al) at −99 ppm.

### Examples 1-8: Preparation of Catalytic Materials

Four FER zeolite samples were obtained as powders from Zeolyst and Tosoh. These samples were loaded with Fe (atomic ratio Fe/Al=0.25 or 0.40), aged and then evaluated for SCR.

For the impregnation, a zeolite was loaded with Fe nitrate solution using incipient wetness impregnation. The mixture was stored for 20 h at 50° C. in an oven. Subsequently, the obtained material was dried and then calcined at 450° C. for 5 h. From the obtained impregnated zeolite a slurry was prepared and Zr-acetate was added (5 weight-% based on zeolite). The resulting mixture was dried under stirring and then calcined for 1 h at 550° C. The obtained material was crushed and sieved (250 to 500 μm). An overview on the characteristics of the prepared catalytic materials is given in Table 1 below.

TABLE 1
Overview of the prepared catalytic materials
according to Examples 1-8.

| | SiO₂:Al₂O₃ | | Atomic ratio |
|---|---|---|---|
| # | molar ratio | Supplier | Fe:Al |
| Ex. 1 | 18 | Zeolyst | 0.25:1 |
| Ex. 2 | 18 | Zeolyst | 0.40:1 |
| Ex. 3 | 20 | Zeolyst | 0.25:1 |
| Ex. 4 | 20 | Zeolyst | 0.40:1 |
| Ex. 5 | 25 | Zeolyst | 0.25:1 |
| Ex. 6 | 25 | Zeolyst | 0.40:1 |
| Ex. 7 | 18 | Tosoh | 0.25:1 |
| Ex. 8 | 18 | Tosoh | 0.40:1 |

For the FER zeolite used for Examples 7 and 8, five peaks were observed in the range of −90.0 to −130.0 ppm. The details of said peaks are shown in table 2 below. In particular, two individual peaks in the range of −93.0 to −101.0 ppm were observed with respect to Q₃(0Al) and Q₄ (2Al) sites, in accordance with the expected peak assignments detailed in Reference Example 1 above with respect to the ²⁹Si MAS NMR.

TABLE 2
Overview of zeolitic materials for Examples 7 and 8 and their properties.

| | | Percentage of total peak area of ²⁹Si MAS NMR spectrum | | | | |
|---|---|---|---|---|---|---|
| | | peak in the | peak in the | peak in the | peak in the | peak in the |
| | | range of | range of | range of | range of | range of |
| | SiO₂:Al₂O₃ | −93.0 to | −97.5 to | −103.5 to | −108.6 to | −112.6 to |
| | molar ratio | −97.0 ppm | −102.5 ppm | −108.5 ppm | −112.5 ppm | −116.5 ppm |
| Ex. 7 + 8 | 18 | 1.45% | 1.44% | 27.62% | 43.08% | 26.40% |

### Examples 9-12: Preparation of Catalytic Materials

Four FER zeolites in the H-form (silica-to-alumina ratio of 15.7, 17.5, 19.7, and 13.3 for Examples 9, 10, 11, and 12, respectively) were obtained from China Catalyst Holding Co., Ltd. These materials were loaded with Fe (5.9-6.0 weight-% Fe₂O₃).

The FER zeolitic materials of Examples 9-11 were analyzed in their H-form prior to ion-exchange with Fe by ²⁹Si MAS NMR. To this effect, the FER zeolites were hydrated for 48 h. The results are shown in Table 3 and FIGS. 1-3. For each FER zeolite, four peaks were observed in the range of −90.0 to −130.0 ppm.

The peak in the range of −103.5 to −108.5 ppm can be assigned to the Q₄(1Al) sites in the FER zeolite. In connection with the results shown in FIG. 6 for the SCR testing, it can be seen that catalytic materials comprising a FER zeolite having a comparatively higher content of Q₄(1Al) sites show a comparatively better SCR performance.

TABLE 3
Overview of catalytic materials according to Examples 9-11 and their properties.

| | | Percentage of total peak area of ²⁹Si MAS NMR spectrum | | | |
|---|---|---|---|---|---|
| | | peak in the | peak in the | peak in the | peak in the |
| | SiO₂:Al₂O₃ | range of −97.5 | range of −103.5 | range of −108.6 | range of −112.6 |
| | molar ratio | to −102.5 ppm | to −108.5 ppm | to −112.5 ppm | to −116.5 ppm |
| Ex. 9 | 15.7 | 2.0% | 40.0% | 20.1% | 37.9% |
| Ex. 10 | 17.5 | 2.8% | 29.0% | 23.5% | 44.7% |
| Ex. 11 | 19.7 | 2.7% | 25.6% | 32.2% | 39.5% |

For the impregnation, a zeolite was loaded with Fe nitrate solution using incipient wetness impregnation. The mixture was stored for 20 h at 50° C. in an oven. Subsequently, the obtained material was dried and then calcined at 450° C. for 5 h. From the obtained impregnated zeolite a slurry was prepared and Zr-acetate was added (5 weight-% based on zeolite). The resulting mixture was dried under stirring and then calcined for 1 h at 550° C. The obtained material was crushed and sieved (250 to 500 μm). Each FER zeolite was loaded with 5.9 to 6.0 weight-% Fe, calculated as Fe₂O₃, and based on the sum of the weights of Fe, calculated as Fe₂O₃, and SiO₂ and Al₂O₃ comprised in the framework structure of the FER zeolite. As noted in Reference Example 1 with respect to the determination of the ²⁹Si MAS NMR spectra for zeolites, a peak in the range of from −103.5.0 to −108.5.0 ppm indicates presence of Q₄ (1Al) sites. In accordance with the present invention, catalytic materials are claimed, which particularly comprise a zeolitic material having a specific Al distribution, thus, especially showing in the deconvoluted ²⁹Si MAS NMR a first peak (P1) having a maximum in said range, while further having a specific integral ratio of the first peak to the integral of all peaks in the range of −90.0 to −130.0 ppm. In this respect, as may be taken from the results displayed in Tables 2 and 3, it is noted that the peak integrals do not correlate with the silica to alumina ratios, such that they describe specific Al distributions in the zeolitic frameworks which are independent of their respective silica to alumina ratios.

### Example 13: Catalytic Testing

The prepared catalytic materials comprising Fe-FER zeolites were tested with respect to their SCR performance in a fresh state (as-prepared), after aging for 50 h at 650° C. in air comprising 10% steam, and after aging for 16 h at 820° C. in air comprising 10% steam.

The following testing conditions were applied:

Standard SCR feed having a gas hourly space velocity (GHSV) of 80000 h⁻¹, and comprising 500 ppm NO, 500 ppm NH₃, 5% H₂O, 10% O₂, balance N₂.

Fast SCR feed having a gas hourly space velocity (GHSV) of 80000 h⁻¹, and comprising 250 ppm NO, 250 ppm NO₂, 500 ppm NH₃, 5% H₂O, 10% O₂, balance N₂.
First run for degreening (Std. SCR feed): T=200, 400, 575° C.
Standard SCR run: T=175, 200, 225, 250, 350, 450, 550, 575° C.
Fast SCR run: T=575, 550, 450, 350, 250, 225, 200, 175° C.

The resulting data for the testing of aged catalytic materials according to Examples 1-8 is shown in FIGS. 4 and 5. As it can be gathered from the results, the catalytic materials in accordance with the present invention showed a very good SCR performance after aging for 50 h at 650° C. in air comprising 10% steam, and a good performance after aging for 16 h at 820° C. in air comprising 10% steam.

The standard SCR performance for the catalytic materials according to Examples 9-11 was measured after 650° C./50 h aging and 820° C./16 h aging. The performance data shown in FIG. 6 demonstrate that the catalytic material comprising a FER zeolite having SAR 15.7 shows the highest SCR activity as compared to the rest of the samples.

### Example 14: Comparative Catalytic Testing

Two types of Fe-zeolites are commonly used currently-Fe-CHA and Fe-BEA. It is widely known that it is difficult to incorporate Fe into the pores of CHA zeolite. An activation with steam or reducing atmosphere is required to incorporate Fe into the pores of CHA zeolites, which significantly adds to the cost of the final Fe-zeolite catalyst. While BEA has the advantage that there is no activation step required to incorporate Fe and make the active catalyst, it is known that BEA can be deactivated by hydrocarbons present in the gas feed. Consequently, Fe-CHA is used in applications that require tolerance to hydrocarbons in place of Fe-BEA. In contrast thereto, FER zeolite provides the advantage of not requiring activation by steam and is at the same time tolerant to hydrocarbons. This is all the more surprising since FER zeolites belong to the group of medium pore zeolites, which particularly comprise pores with 10 membered rings, which are typically considered as not showing as much steric hindrance as observed for small pore zeolites.

Additionally, FER zeolites also show tolerance to humidity treatment.

A comparative catalytic testing was carried out, wherein a state-of-the-art Fe-BEA, a state-of-the-art Fe-CHA, and catalytic materials in accordance with Examples 2 and 7 were tested in the fresh state as well as after aging for 50 h at 650° C. in air comprising 10% steam.

The results for the catalytic testing are shown in FIG. 7. As it can be gathered from the results, the catalytic materials according to the present invention show a very good performance, in particular at low temperatures. At high temperatures, especially the catalytic materials in the fresh state show a very good performance.

### Example 15: Preparation of a Catalytic Article Comprising Fe/FER (SAR=18, Fe₂O₃%=5.4%)

89.9 parts by weight of the ammonium-form of FER, 5.1 parts by weight of Iron nitrate calculated as Fe₂O₃ and 5.0 parts by weight of zirconium acetate calculated as ZrO₂ were mixed into deionized water to form a slurry. pH of the slurry is adjusted to 3.3 with TEAOH solution. The slurry was milled to a particle size of D90 between 4 μm to 10 μm, as measured with a Sympatec particle size analyzer. The slurry was coated onto a flow-through cordierite monolith substrate having a cell density of 600 cpsi and a wall thickness of 3 mil, followed by drying at 130° C. and calcination at 590° C. The washcoat loading was 2.5 g/in³.

### Example 16: Preparation of a Catalytic Article Comprising Fe/FER (SAR=18, Fe₂O₃%=2.5%)

92.6 parts by weight of the ammonium-form of FER, 2.4 parts by weight of Iron nitrate calculated as Fe₂O₃ and 5.0 parts by weight of zirconium acetate calculated as ZrO₂ were mixed into deionized water to form a slurry. pH of the slurry is adjusted to 3.3 with TEAOH solution. The slurry was milled to a particle size of D90 between 4 μm to 10 μm, as measured with a Sympatec particle size analyzer. The slurry was coated onto a flow-through cordierite monolith substrate having a cell density of 600 cpsi and a wall thickness of 3 mil, followed by drying at 130° C. and calcination at 590° C. The washcoat loading was 2.5 g/in³.

### Example 17: Preparation of a Catalytic Article Comprising Fe/FER (SAR=17, Fe₂O₃%=5.4%)

89.9 parts by weight of the ammonium-form of FER, 5.1 parts by weight of Iron nitrate calculated as Fe₂O₃ and 5.0 parts by weight of zirconium acetate calculated as ZrO₂ were mixed into deionized water to form a slurry. pH of the slurry is adjusted to 3.3 with NH₄OH solution. The slurry was milled to a particle size of D90 between 4 μm to 10 μm, as measured with a Sympatec particle size analyzer. The slurry was coated onto a flow-through cordierite monolith substrate having a cell density of 600 cpsi and a wall thickness of 3 mil, followed by drying at 130° C. and calcination at 590° C. The washcoat loading was 3.0 g/in³.

### Example 18: Preparation of a Catalytic Article Comprising Fe/FER (SAR=17, Fe₂O₃%=5.4%)

89.9 parts by weight of the ammonium-form of FER, 5.1 parts by weight of Iron ammonium citrate calculated as Fe₂O₃ and 5.0 parts by weight of zirconium acetate calculated as ZrO₂ were mixed into deionized water to form a slurry. The slurry was milled to a particle size of D90 between 4 μm to 10 μm, as measured with a Sympatec particle size analyzer. The slurry was coated onto a flow-through cordierite monolith substrate having a cell density of 600 cpsi and a wall thickness of 3 mil, followed by drying at 130° C. and calcination at 590° C. The washcoat loading was 2.5 g/in³.

### Example 19: Preparation of a Catalytic Article Comprising Fe/FER (SAR=17, Fe₂O₃%=5.4%)

89.9 parts by weight of the ammonium-form of FER, 5.1 parts by weight of Iron(II) ascorbate solution calculated as Fe₂O₃ and 5.0 parts by weight of zirconium acetate calculated as ZrO₂ were mixed into deionized water to form a slurry. The slurry was milled to a particle size of D90 between 4 μm to 10 μm, as measured with a Sympatec particle size analyzer. The slurry was coated onto a flow-through cordierite monolith substrate having a cell density of 600 cpsi and a wall thickness of 3 mil, followed by drying at 130° C. and calcination at 590° C. The washcoat loading was 2.5 g/in³.

### Example 20: Preparation of a Catalytic Article Comprising Fe/FER (SAR=16, Fe₂O₃%=5.4%)

89.9 parts by weight of the hydrogen-form of FER, 5.1 parts by weight of Iron nitrate calculated as Fe₂O₃ and 5.0 parts by weight of zirconium acetate calculated as ZrO₂ were mixed into deionized water to form a slurry. pH of the slurry is adjusted to 3.3 with TEAOH solution. The slurry was milled to a particle size of D90 between 4 μm to 10 μm, as measured with a Sympatec particle size analyzer. The slurry was coated onto a flow-through cordierite monolith substrate having a cell density of 600 cpsi and a wall thickness of 3 mil, followed by drying at 130° C. and calcination at 590° C. The washcoat loading was 2.5 g/in³.

### Example 21: Preparation of a Catalytic Article Comprising Fe/FER (SAR=17, Fe₂O₃%=5.5%)

82 parts by weight of deionized water is combined with 12.8 parts by weight of ammonium-form FER zeolite and 5.2 parts by weight of Ferric nitrate solution (9.5 weight-% aqueous solution, calculated as Fe₂O₃). This solution is heated to 60° C. under stirring and then the pH is adjusted to 5.0-5.15 by the use of tetraethylammonium hydroxide (35 weight-% aqueous solution) as a base. After pH adjustment, the solution is stirred for 1 hour at 60° C. before cutting off the heat. The cooled solution is filtered and washed with deionized water until the conductivity of the filtrate is lower than 200 pS. The filtercake is then dried overnight at 90° C. to obtain Fe/FER with 5.5% Fe₂O₃.

95 parts by weight of Fe/FER containing 5.5% of Fe₂O₃ and 5.0 parts by weight of zirconium acetate calculated as ZrO₂ were mixed into deionized water to form a slurry. The slurry was milled to a particle size of D90 between 4 μm to 10 μm, as measured with a Sympatec particle size analyzer. The slurry was coated onto a flow-through cordierite monolith substrate having a cell density of 600 cpsi and a wall thickness of 3 mil, followed by drying at 130° C. and calcination at 590° C. The washcoat loading was 2.5 g/in³.

### Example 22: Catalytic Testing

The NOx conversion and N₂O formation was tested using a flow reactor under pseudo-steady state conditions with a gas stream of 1000 ppmv NOx (NO₂/NOx ratio 0.5), 1050 ppmv NH₃, 10 vol % O₂, 7 vol % H₂O, 8 vol % CO₂ and balanced N₂, at a space velocity of 60,000 h⁻¹. SCR catalysts were hydrothermally aged in 10% 02, 10% H₂O and balanced N₂ at 650° C. for 100 h, or degreened in 10% O₂, 10% H₂O and balanced N₂ at 550° C. for 4 h. All inventive examples 15 to 21 show improved NOx conversion over the state of art Fe/CHA SCR as shown in FIGS. 8-11.

It is shown in FIG. 12 that the inventive SCR catalyst maintains high NOx conversion at low temperature such as 200° C. with extended testing time. On the contrary, low temperature NOx conversion of the state of art Fe/CHA decreases with extended testing time, likely due to formation of NH₄NO₃ that partially blocks active sites.

The inventive SCR catalyst according to Example 17 was tested after aging with respect to its HC resistance. The testing conditions were as follows: 200 ppm NO, Ammonia/NOx ratio 1.05, 1000 ppm HC (C₁ basis, 2:1 C₃H₆:C₃H₈), 10% O₂, 7% H₂O, 80 k/h SV, 300° C. The results are shown in FIG. 13.

As it can be gathered from the results for catalytic testing, the catalytic materials according to the present invention, which are particularly characterized in showing in the deconvoluted ²⁹Si MAS NMR of the zeolitic material a first peak (P1) having a maximum in the range of from −103.5 to −108.5 ppm, wherein the integral of the first peak affords a specific area I₁ relative to the area Iₜₒₜₐₗ of all peaks, achieve a favorable SCR activity, especially after hydrothermal aging.

### BRIEF DESCRIPTION OF FIGURES

FIG. 1: shows the deconvoluted ²⁹Si MAS NMR spectrum of the zeolitic material (SAR=19.7) used for the preparation of the catalytic material according to Example 11. On the abscissa, the shift is noted in ppm.

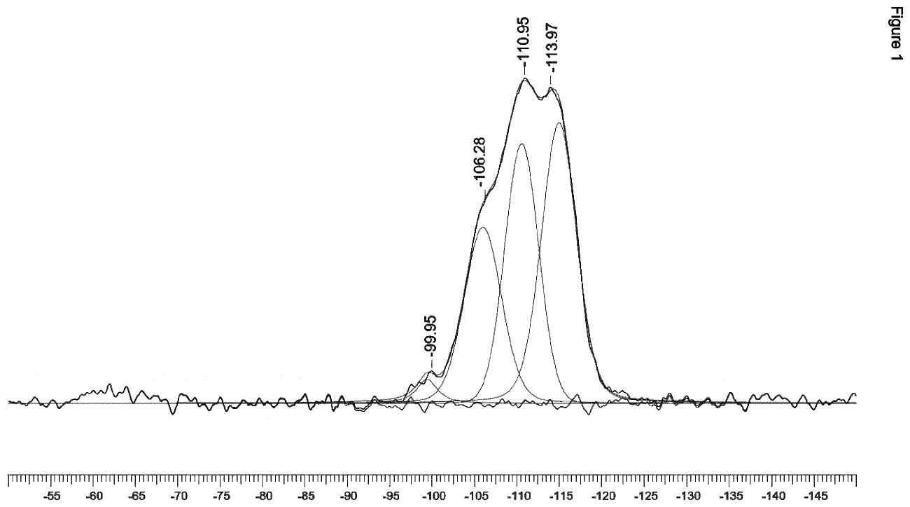

FIG. 2: shows the deconvoluted ²⁹Si MAS NMR spectrum of the zeolitic material (SAR=15.7) used for the preparation of the catalytic material according to Example 9. On the abscissa, the shift is noted in ppm.

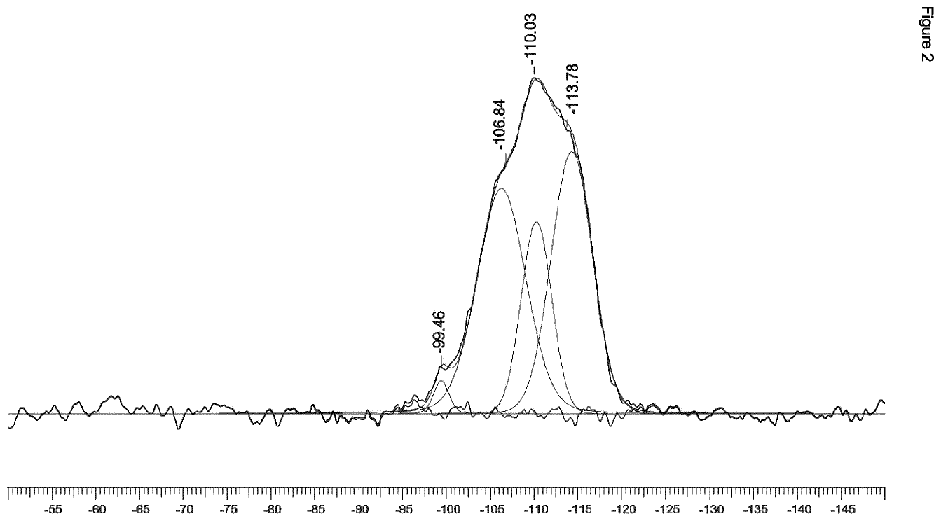

FIG. 3: shows the deconvoluted ²⁹Si MAS NMR spectrum of the zeolitic material (SAR=17.5) used for the preparation of the catalytic material according to Example 10. On the abscissa, the shift is noted in ppm.

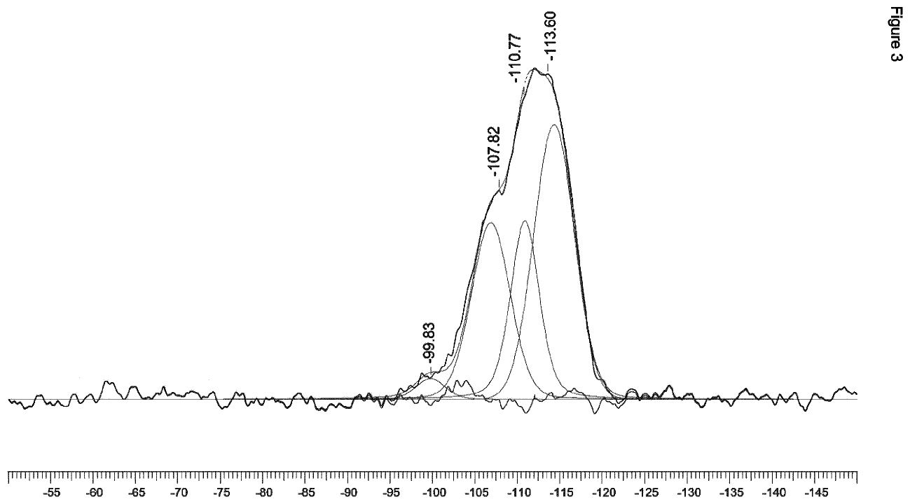

FIG. 4: shows the results for the catalytic testing of aged catalytic materials according to Examples 1-8. On the abscissa, the temperature is shown in ° C. and on the ordinate, the NOx conversion is shown in %.

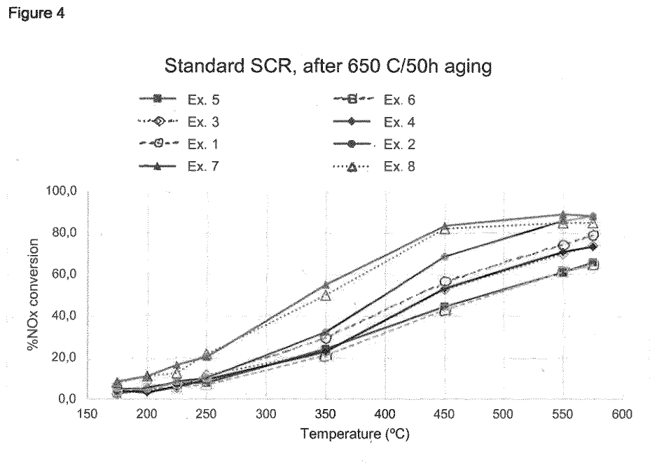

FIG. 5: shows the results for the catalytic testing of aged catalytic materials according to Examples 1-8. On the abscissa, the temperature is shown in ° C. and on the ordinate, the NOx conversion is shown in %.

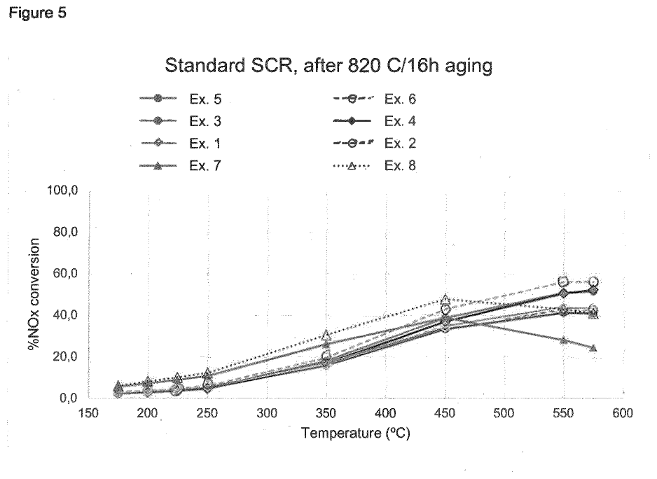

FIG. 6: shows the standard SCR performance for the catalytic materials according to Examples 9-12 after aging. On the abscissa, the temperature is shown in ° C. and on the ordinate, the NOx conversion is shown in %.

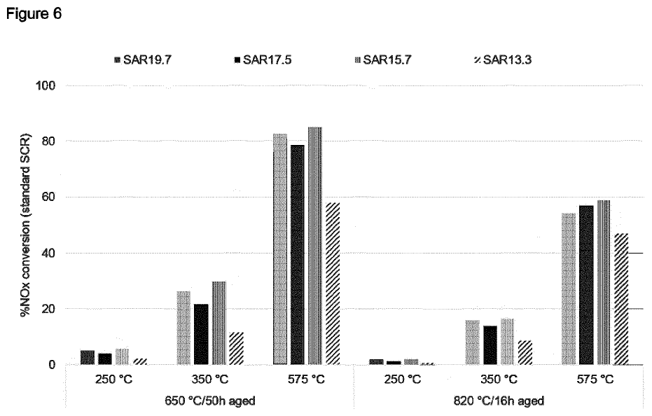

FIG. 7: shows the results for comparative catalytic testing of a state-of-the-art Fe-BEA, a state-of-the-art Fe-CHA, and catalytic materials in accordance with Examples 2 and 7 in the fresh state as well as after aging. On the abscissa, the temperature is shown in ° C. and on the ordinate, the NOx conversion is shown in %.

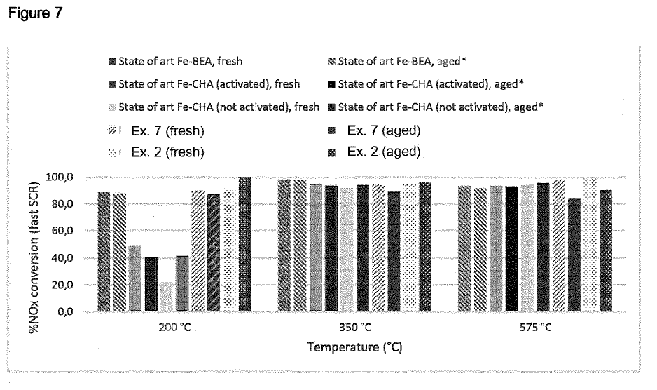

FIG. 8: shows the results for the catalytic testing of the catalytic materials according to Examples 15, 17, 19-20, and a state-of-the-art Fe-CHA. On the abscissa, the temperature is shown in ° C. and on the ordinate, the NOx conversion is shown in %.

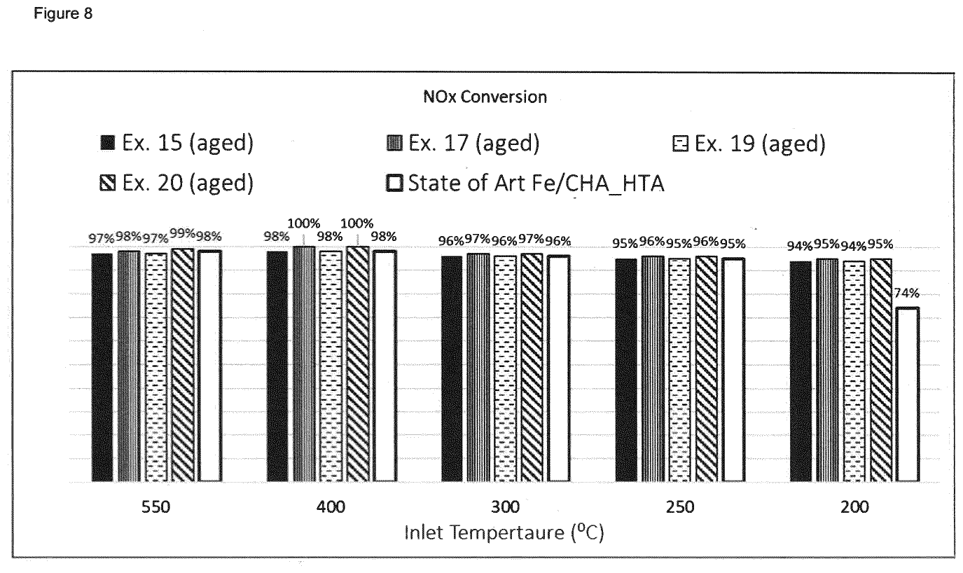

FIG. 9: shows the results for the catalytic testing of the catalytic materials according to Examples 15, 17, 19-20, and a state-of-the-art Fe-CHA. On the abscissa, the temperature is shown in ° C. and on the ordinate, the N₂O formation is shown ppm.

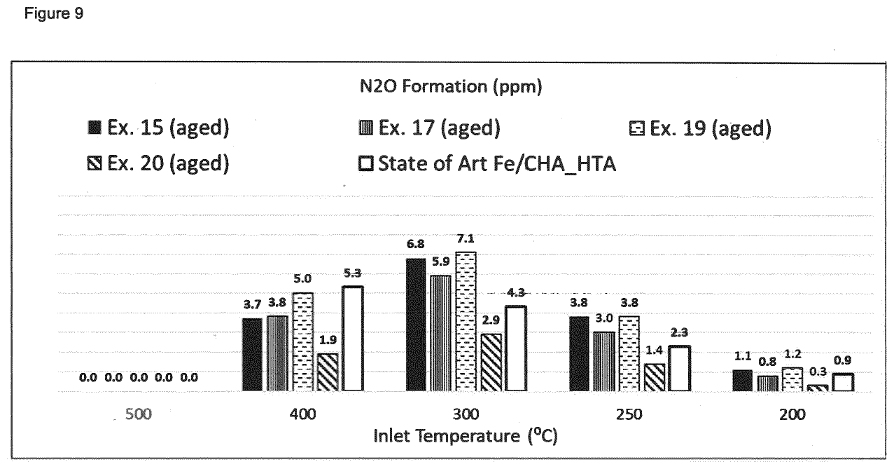

FIG. 10: shows the results for the catalytic testing of the catalytic materials according to Examples 18, 21, and a state-of-the-art Fe-CHA. On the abscissa, the temperature is shown in ° C. and on the ordinate, the NOx conversion is shown in %.

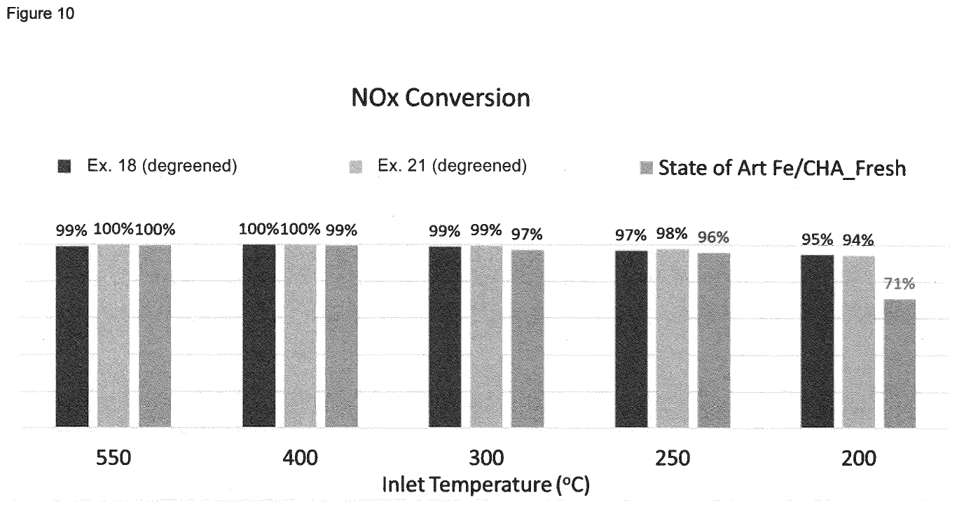

FIG. 11: shows the results for the catalytic testing of the catalytic materials according to Examples 18, 21, and a state-of-the-art Fe-CHA. On the abscissa, the temperature is shown in ° C. and on the ordinate, the N₂O formation is shown ppm.

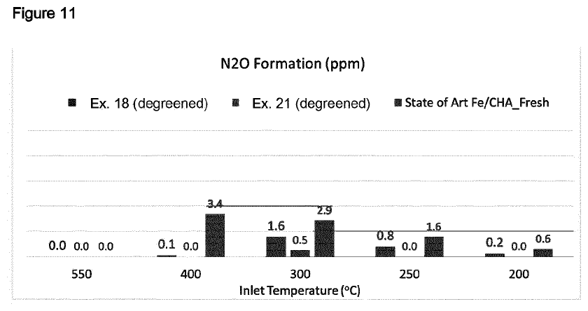

FIG. 12: shows the outlet NOx concentration in a catalytic test at 200° C. for the catalytic material according to example 15 and a state-of-the-art Fe-CHA. On the abscissa, the time is shown in seconds and on the ordinate, the NOx concentration is shown in ppm.

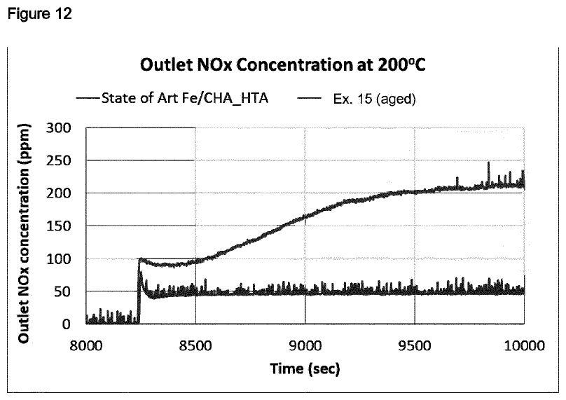

FIG. 13: shows the results of the hydrocarbon tolerance test for the catalytic material according to Example 17 after aging. On the abscissa, the time is shown in seconds and on the ordinate, the hydrocarbon concentration is shown in ppm.

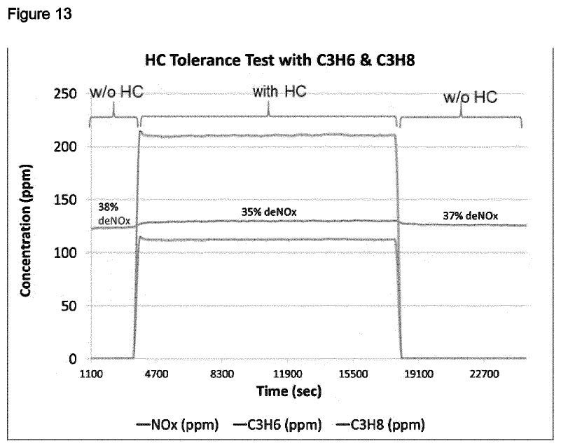

FIG. 14: shows two exemplary exhaust gas treatment systems, wherein both exemplary systems include in consecutive order in the direction of exhaust gas flow a hydrocarbon injector, a diesel oxidation catalyst (DOC), a catalyzed soot filter (CSF), an urea injector, a component comprising the catalytic material in accordance with the present invention (SCR1), and a combined selective catalytic reduction/ammonia oxidation catalyst. The exemplary system in the lower part additionally comprises a close coupled selective catalytic reduction (cc-SCR) catalyst upstream of the hydrocarbon injector.

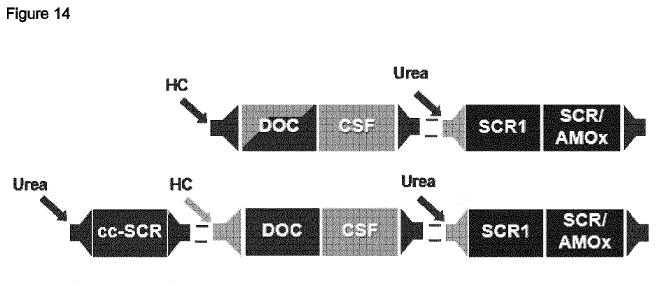

### CITED LITERATURE

WO 2020/021054 A1
WO 2021/198339 A1
WO 2015/128668 A1
EP 2857084 A1
DE 10 2011 012799 A1
EP 2409760 A1
WO 2008/049557 A1
U.S. Pat. No. 5,041,272 A
US 2011/056187 A1
P. Sarv et al., “Multinuclear MQMAS NMR Study of NH₄/Na-Ferrierites”, J. Phys. Chem. B 1998, 102, 1372-1378

1. A catalytic material for the selective catalytic reduction of NOx, the catalytic material comprising
a zeolitic material comprising SiO₂ and X₂O₃ in its framework structure,
wherein X is a trivalent element,
wherein the zeolitic material has an FER-type framework structure,
wherein the deconvoluted ²⁹Si MAS NMR of the zeolitic material comprises a first peak (P1) having a maximum in the range of from −103.5 to −108.5 ppm, wherein the integral of the first peak affords an area I₁, wherein the integral of all peaks in the range of −90.0 to −130.0 ppm afford an area Iₜₒₜₐₗ, wherein the ratio of the area I₁ of the first peak to the area Iₜₒₜₐₗ of all peaks is equal to or greater than 0.20:1,
wherein the catalytic material comprises Fe, wherein Fe is supported on the zeolitic material.

2. The catalytic material of claim 1, wherein the deconvoluted ²⁹Si MAS NM R of the zeolitic material comprises a second peak (P2) having a maximum in the range of −97.5 to −102.5 ppm.

3. The catalytic material of claim 1, wherein the deconvoluted ²⁹Si MAS NMR of the zeolitic material comprises a third peak (P3) having a maximum in the range of −108.6 to −112.5 ppm.

4. The catalytic material of claim 1, wherein the deconvoluted ²⁹Si MAS NMR of the zeolitic material comprises a fourth peak (P4) having a maximum in the range of −112.6 to −116.5 ppm.

5. The catalytic material of claim 1, wherein the deconvoluted ²⁹Si MAS NMR of the zeolitic material comprises a fifth peak (P5) having a maximum in the range of −93.0 to −97.0 ppm.

6. The catalytic material of claim 1, wherein X is selected from the group consisting of Al, B, In, Ga, and mixtures of two or more thereof.

7. The catalytic material of claim 1, wherein the zeolitic material has a molar ratio of SiO₂ to X₂O₃ of equal to or less than 50.

8. The catalytic material of claim 1, having an atomic ratio of Fe supported on the zeolitic material, calculated as element, to Al comprised in the framework structure of the zeolitic material, calculated as element, of equal to or greater than 0.20:1.

9. The catalytic material of claim 1, comprising Fe, calculated as Fe₂O₃, supported on the zeolitic material, calculated as sum of the weights of SiO₂ and X₂O₃ comprised by the framework structure of the zeolitic material, in an amount of from 4.0 to 6.5 weight-%.

10. A process for producing a catalytic material, preferably for producing the catalytic material according to claim 1, the process comprising
(i) providing an aqueous mixture comprising a zeolitic material, one or more sources of Fe, and one or more optionally substituted ammonium cations;
(ii) subjecting the mixture obtained in (i) to ion-exchange conditions;
wherein the zeolitic material comprises SiO₂ and X₂O₃ in its framework structure, wherein X is a trivalent element,
wherein the zeolitic material has a maximum ring size of 10 T-atoms or less,
wherein the deconvoluted ²⁹Si MAS NMR of the zeolitic material comprises a first peak (P1) having a maximum in the range of from −103.5 to −108.5 ppm, wherein the integral of the first peak affords an area I₁, wherein all peaks in the range of −90.0 to −130.0 ppm have an area Iₜₒₜₐₗ, wherein the ratio of the area I₁ of the first peak to the area Iₜₒₜₐₗ of all peaks is equal to or greater than 0.20:1, and Fe supported on the zeolitic material.

11. The process of claim 10, wherein the one or more optionally substituted ammonium cations are selected from the group consisting of NH₄⁺, ((C₁-C₁₀)alkyl)NH₃⁺, ((C₁-C₁₀) alkyl)₂NH₂⁺, ((C₁-C₁₀)alkyl)₃NH⁺, ((C₁-C₁₀)alkyl)₄N⁺, and mixtures of two or more thereof.

12. A catalytic material obtained or obtainable by the process of claim 10.

13. An exhaust gas treatment system comprising a component comprising the catalytic material of claim 1, an internal combustion engine and an exhaust gas conduit in fluid communication with the internal combustion engine, wherein the component comprising the catalytic material is present in the exhaust gas conduit.

14. A process for the treatment of an exhaust gas, the process comprising bringing the exhaust gas stream in contact with a catalytic material according to claim 1.

15. Use of a catalytic material according to claim 1 or of an exhaust gas treatment system for the treatment of an exhaust gas comprising NOx.

16. The catalytic material of claim 2, wherein the deconvoluted ²⁹Si MAS NMR of the zeolitic material comprises a third peak (P3) having a maximum in the range of −108.6 to −112.5 ppm.
